(19) United States
(12) Patent Application Publication
(10) Pub. No.: US 2016/0087554 A1
(43) Pub. Date: Mar. 24, 2016

(54) SMART MONITORING AND CONTROL SYSTEM AND METHOD OF OPERATION

(71) Applicant: Delta Systems, Inc., Streetsboro, OH (US)

(72) Inventor: TANIOS NOHRA, Broadview Heights, OH (US)

(21) Appl. No.: 14/810,060

(22) Filed: Jul. 27, 2015

Related U.S. Application Data
(60) Provisional application No. 62/052,297, filed on Sep. 18, 2014.

(51) Int. Cl. H02N 2/18; G05B 13/02; G06Q 10/00; H04W 4/00; H04W 72/04

(52) U.S. Cl. CPC H02N 2/181; H04W 4/008; H04W 72/0413; G06Q 10/20; G05B 13/024

(57) ABSTRACT

One aspect of the present disclosure can include a system that can be used to monitor and/or control a power generation device. The system can include a non-transitory memory storing computer-executable instructions; and a processor configured to facilitate execution of the computer-executable instructions to at least receive a first wireless signal comprising information related to a parameter of operation of a power generator device from the power generator device; modify control information for an operation of the power generator device based on the information related to the parameter of operation of the power generator device; and transmit a second wireless signal comprising the control information for the operation of the power generator device to the power generator device. Methods and apparatuses that can monitor and/or control the power generation device are also described.

### CROSS REFERENCES TO RELATED APPLICATIONS

The following application claims priority under 35 U.S.C. §119(e) to co-pending U.S. Provisional Patent Application Ser. No. 62/052,297 filed Sep. 18, 2014 entitled SMART MONITORING AND CONTROL SYSTEM AND METHOD OF OPERATION. The above-identified application is incorporated herein by reference in its entirety for all purposes.

### TECHNICAL FIELD

The present disclosure relates to a smart monitoring and control system and method of operation, and in particular, a smart monitoring and control system that uses a remote wireless protocol to transmit information relating to a power generator to a mobile computing device.

### BACKGROUND

Power generators can provide temporary or remote electric power. However, these power generators can also be hazardous to human and animal health when used in a confined space. For example, power generators can emit toxic engine exhaust that contains carbon monoxide, a colorless, odorless gas that can kill a person or animal in mere minutes. Accordingly, power generators never should be used inside confined areas, like homes, garages, crawl spaces, sheds, or similar areas, even when fans, open doors, or open windows are used for ventilation. Instead, power generators must be located outdoors at a proper distance from doors, windows, and vents that could allow carbon monoxide to come indoors.

Even when these power generators are used outside, it is still important to know whether they are emitting poisonous gas. It is also important to know if the voltage of the generator is within a safe range. Additionally, the owner and/or manufacturer of the power generator also needs to know how long the engine has been operated, when the equipment is due for repair/maintenance service, and whether the equipment is still under warranty.

### SUMMARY

One aspect of the present disclosure includes a “smart monitoring and control system” system. For example, the system can be used to monitor and/or control a power generation device. The system can include a non-transitory memory storing computer-executable instructions; and a processor configured to facilitate execution of the computer-executable instructions to at least: receive a first wireless signal comprising information related to a parameter of operation of a power generator device from the power generator device; modify control information for an operation of the power generator device based on the information related to the parameter of operation of the power generator device; and transmit a second wireless signal comprising the control information for the operation of the power generator device to the power generator device.

Another aspect of the present disclosure includes method for monitoring and/or controlling a power generation device. The method can be performed and/or executed by a system that includes a non-transitory memory and a processor. Upon execution, the method can include: detecting a parameter of operation of a power generator device; transmitting a first wireless signal comprising information related to the parameter of operation of the power generator device; receiving a second wireless signal comprising control information for an operation of the power generator device to the power generator device based on the parameter of operation of the power generator device; and modifying, by the system, the operation of the power generator device based on the control information.

A further aspect of the present disclosure includes a non-transitory computer-readable storage medium storing computer-executable instructions that, when executed by a computing device comprising a processor, cause the computing device to perform operations. For example, the operations can facilitate monitoring and/or controlling a power generation device. The operations can include: receiving a first wireless signal comprising information related to a parameter of operation of a power generator device from the power generator device; modifying control information for an operation of the power generator device based on the information related to the parameter of operation of the power generator device; and transmitting a second wireless signal comprising the control information for the operation of the power generator device to the power generator device.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals refer to like parts unless described otherwise throughout the drawings and in which:

FIG. 1 is a block diagram illustrating an example of a “smart monitoring and control” system that can facilitate bi-directional communication between a control device of a power generator and a computing device in accordance with an aspect of the present disclosure;

FIGS. 2 and 3 are example block diagrams illustrating the control device of FIG. 1;

FIG. 4 is block diagram illustrating an example configuration of the system of FIG. 1;

FIG. 5 shows example graphical user interfaces of the system of FIG. 1 as shown on the remote device;

FIG. 6 is an example state machine diagram for the control device of FIG. 1; and

FIG. 7 is a process flow diagram of a method for monitoring and controlling a power generator device in accordance with another aspect of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure relates to a smart monitoring of a power generator device and control system and method of operation, and in particular, a smart monitoring and control system using a remote wireless protocol to transmit information relating to the power generator device to a mobile computing device.

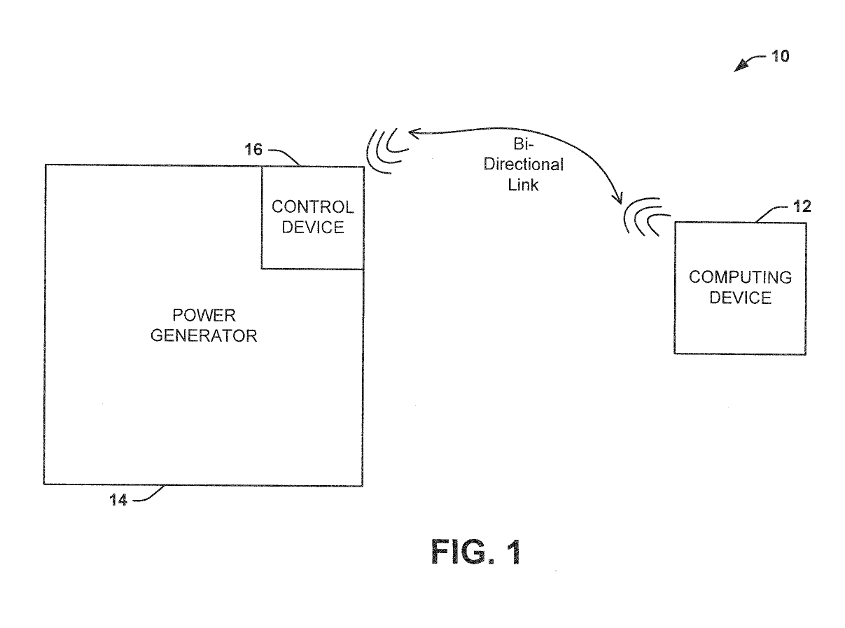

With reference now to the figures and in particular to FIG. 1, illustrated is an example of a “smart monitoring and control” system 10 in accordance with an aspect of the present disclosure. The system 10 can include a power generator 14, a control device 16 and a computing device 12. In some instances, the system 10 can facilitate bi-directional communication between the control device 16, which can be coupled to the power generator 14, and the computing device 12.

In some instances, the power generator 14 can be a portable and/or cordless and/or battery-powered power generation device. The power generator 14 can include an instrument panel that can be used for operating the power generation of the power generator 14. The instrument panel can include an ignition switch for starting an engine associated with the power generator to facilitate the generation of power. The instrument panel can also include one or more indicator display modules, such as an hour meter. The power generator 14 can be associated with a specific serial number (e.g., in the form of a barcode or quick response code (QR) that additionally identifies the model number, type of the power generator, and/or details of the owner of the power equipment such as the owner's address, email address, phone, name, and business). The computing device 12 can include a keyboard allowing for the keying in of the serial number 40 or alternatively scans the barcode or QR to provide register information to a computer or database associated with a third party that includes a part supplier, power equipment dealer, service store, and the like. Communication of the register information to such computers and/or databases can be achieved via a wireless protocol such as WiFi or over a global wireless network such as the Internet 47. In one example embodiment, the computing device 12 includes, but is not limited to, a smart phone, tablet, wireless router, and the like.

The control device 16 (or “smart controller”) can be coupled to the power generator 14 and configured to control one or more functions of the power generator. For example, the control device 16 can include one or more sensors, a transmitter/receiver, and a controller (e.g., a PLC, a microcontroller, an application specific analog circuit (ASIC), a processor, etc.). In some instances, the control device 16 can be a slave device that is coupled to the engine in such a way to analyze, store, transmit, and receive, inner-active information related to the operation of the power generator 14. For example, the information can include, but is not limited to, hours of engine operation, oil pressure, fuel level, engine temperature, location, power generation voltage, CO emissions, mechanical wear, service reminders, operation trouble shooting guidance, link to service or part suppliers, signature identification unique to power generator, remote operation/control, remote status check (ON or OFF), time stamping, remote start-up, remote brake, and remote power-take-off (PTO) enablement and disablement.

The control device 16 can be located on or near the engine of the power generation device, but could be positioned at other locations on the power generator 14 (e.g., different sensors can be positioned at the most appropriate locations for detecting their assigned parameter) without departing from the spirit and scope of the present disclosure. The control device 16 can receives its power from a power supply that is also used by the power generator 14, such as a battery. In other instances, the control device 16 can include its own power supply.

The control device 16 and the computing device 12 can engage in bi-directional communication according to a communications protocol that allows bidirectional wireless communication. One example of such a protocol is the Bluetooth communication protocol and/or the Bluetooth low energy (BLE) communication protocol. The BLE protocol allows for minimal power consumption for both the central control device 16 and remote computing device 12 (e.g., in the range of 18 mA) at a range of 150 feet separating the control device and the computing device. It should be appreciated that other wireless protocols 38 could be used such as ANT+, without departing from the spirit and scope of the present disclosure.

In some instances, the computing device 12 can be a mobile computing device (e.g., a smart phone, a tablet computing device, a laptop computer, router, such as a wireless IPv6 router, and/or a personal digital assistant). To facilitate the bi-directional communication, both the control device 16 and the computing device 12 can have transmitters and receivers configured to permit the bidirectional wireless communication. Both the control device 16 and the computing device 12 can include a transceiver for sending monitoring and/or control information and a receiver fur receiving and receiving monitoring and/or control information according to the wireless protocol. For example, the transmitters and receivers can modulate the information onto a radio frequency and transmit it through a respective antenna operatively connected to transceivers/receivers of the respective device, as well as demodulate and digitize the radio frequency signals received by the antennas to provide data in a useful form for digital processing by both the computing device 12 and the control device 16.

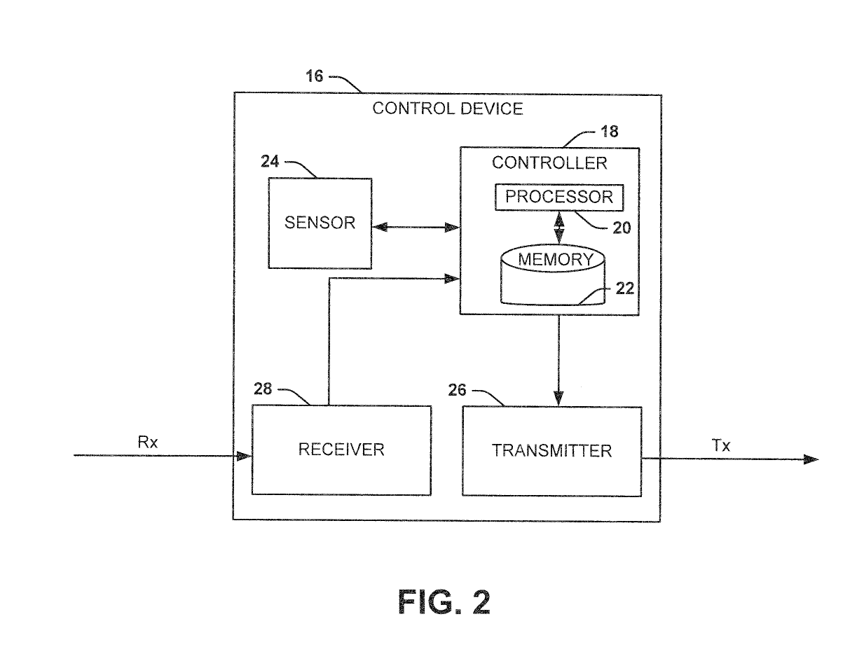

As shown in FIG. 2, the control device 16 can include a transmitter 26 and a receiver 28. The transmitter 26 can be configured to transmit a signal (Tx) according to the communication protocol and the receiver 28 can be configured to receive another signal (Rx) according to the communication protocol. In some instances, the transmitter 23 and the receiver 28 can be embodied in a single device (e.g., a radio transmitter). One suitable radio transmitter is sold under part number CC2540, which is commercially available by Texas instruments, the specification data sheet being incorporated herein by reference.

The control device can include one or more sensors 24 and a controller (e.g., a programmable logic controller (PLC)) that can include a non-transitory memory 20 storing computer-executable instructions and a processor 22 configured to facilitate execution of the computer-executable instructions. Upon execution, the controller 18 can signal the transmitter 26 to transmit a wireless signal (Tx) that includes information related to a parameter of operation of the power generator device (e.g., recorded by sensor 24). In response, the receiver 28 can receive another wireless signal (Rx) from the computing device that can signal the controller to modify the control information for an operation of the power generator device based on the parameter of operation of the power generator device. The controller 18 can utilize the information within signal (Rx) to control the power generator device.

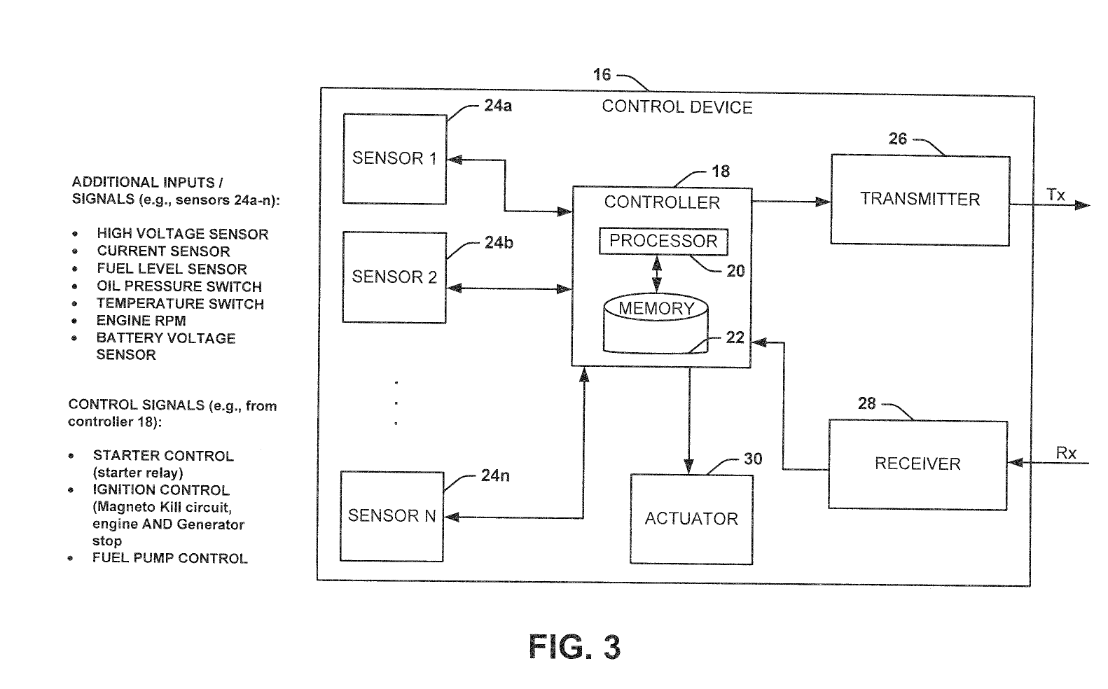

As shown in FIG. 3, the sensor 24 can include N sensors (24a-24N), where N is an integer greater than or equal to 2. For example, the sensors can include, but are not limited to, a CO sensor, a high voltage sensor, a current sensor, a fuel level sensor, an oil pressure sensor, a temperature sensor, an engine RPM sensor, and/or a battery voltage sensor. The controller 18 can configure control signals for the power generator, such as, but not limited to, a starter relay, an ignition control (e.g., a magneto kill circuit, engine stop, generator stop, etc.), a fuel pump control, and the like.

For example, one of the sensors (e.g., 24a) can be a CO sensor configured to detect a presence of CO in an emission from the power generator device. The sensor can communicate the data to the controller 18, which can determine whether the CO emissions are above a threshold and/or increasing at a rate necessitating an alarm. When the CO emissions are above the threshold, the controller can set an emergency kill of the operations of the generator (e.g., via actuator 30) and/or transmit a signal (Tx) to the computing device. In some instances, the computing device can send a signal (Rx) to the receiver 28 that contains data related to a desired operation for the power generator. The receiver 28 can transmit the data to the controller 18, which can control the power generator device based on the data.

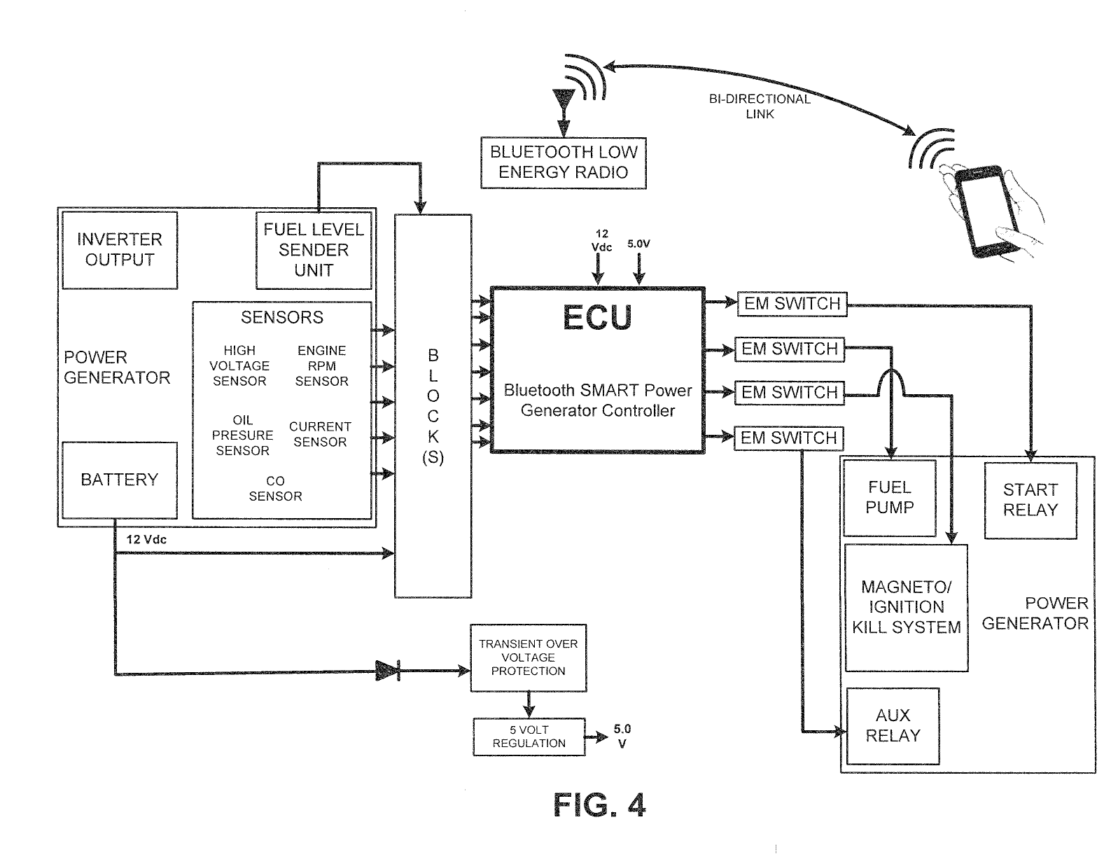

A block diagram illustrating an example configuration of the system of FIG. 1 is shown in FIG. 4. As illustrated in FIG. 4, the control device can include the ECU, the fuel level sender unit, the blocks, the EM switches, and the sensors. The power generator can also include a fuel pump, a battery, a start relay, an auxiliary relay, and a kill switch.

The controller can monitor available power generator sensors, process the onboard sensor output data and wirelessly send information about the current generator state of operation to the computing device. For example, the controller can provide data to an application (or APP) on a smart phone, a tablet computing device, a laptop computing device or the like. The application allows a user to remotely control and monitor the operation of the power generator, including the start and stop of the generator, battery voltage, output voltage, running power consumption, ran hours, due and required maintenance, and service reminders will allow the user to remotely interact, monitor, and control the generator without leaving the house or walking up to the generator.

The available wireless data can be received by any listening smart device such as Smartphone, laptop computer, or tablet when unpaired, or only by the paired master device when paired. Starting and stopping the generator could only take place over a secured communication link and therefore the wireless Bluetooth controller must he paired to a master device. An anti-theft feature can be implemented using the Received Signal Strength Indicator (RSSI) value usually sent from the controller. The RSSI value is an indication about how far the generator is from the receiving master device. If the RSSI signal is not received, an automatic shat-down is triggered. The application can include help on generator operating tips, installation and support, wattage chart indicating power requirement per each typical house appliance, and frequently asked questions.

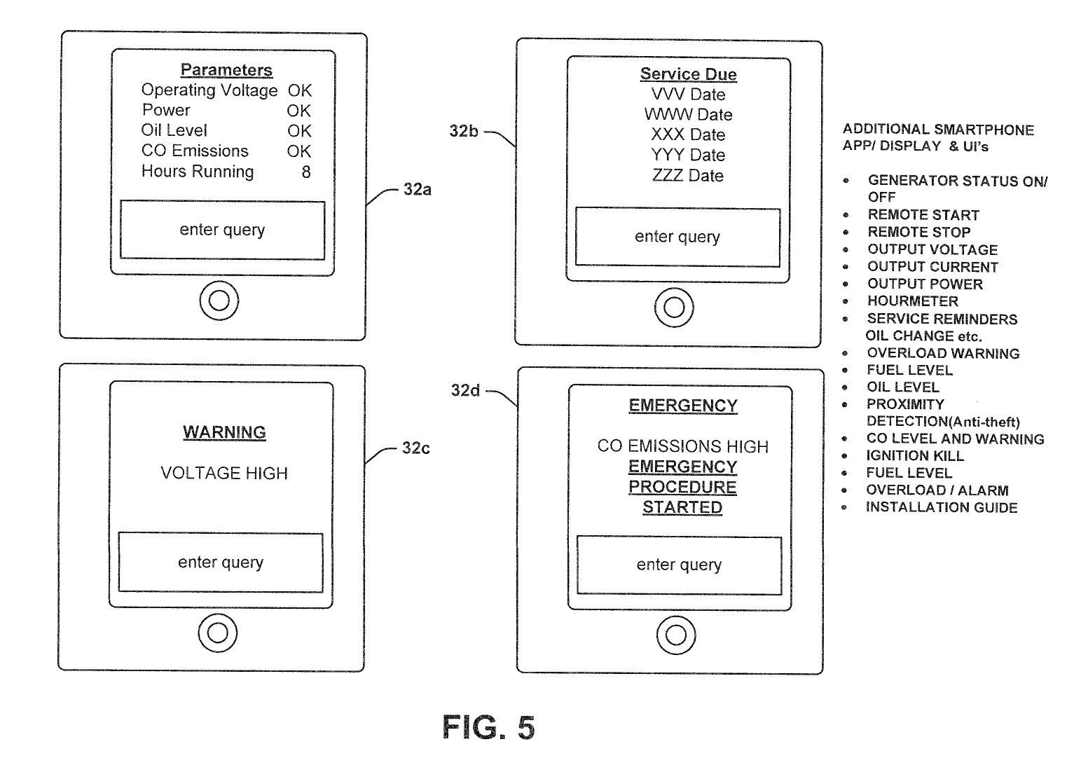

The application can provide a graphical user interface based on the data. FIG. 5 illustrates examples of graphical user interfaces 32a-d that can be displayed on the computing device 12 based on data within the signal transmitted (Tx) from the control device 16. For example, interface 32a can show the status of various operations of the power generator 14. Interface 32b can show when various services for the power generator 14 are due. Interface 32c can provide a warning (which can be in connection with an audio or visual alarm) of an error found within the operations of the system). Interface 32d can illustrate an emergency situation for the power generator 14 (which can be in connection with an audio or visual alarm) that cause the control device to issue an emergency shut off of the power generator. Additional components and/or user interfaces can include, but are not limited to: generator status on/off, remote start, remote stop, output voltage, output current output power, hourmeter, service reminder, service reminders (e.g., oil change, filter change, replacement of battery, replacement of oil, total hours run, video instructions, written instructions, location of service center, where to purchase necessary parts), overload warning, fuel level, oil level, proximity detection (e.g., anti-theft), CO level and warning, ignition kill fuel level, overload/alarm, and installation guide.

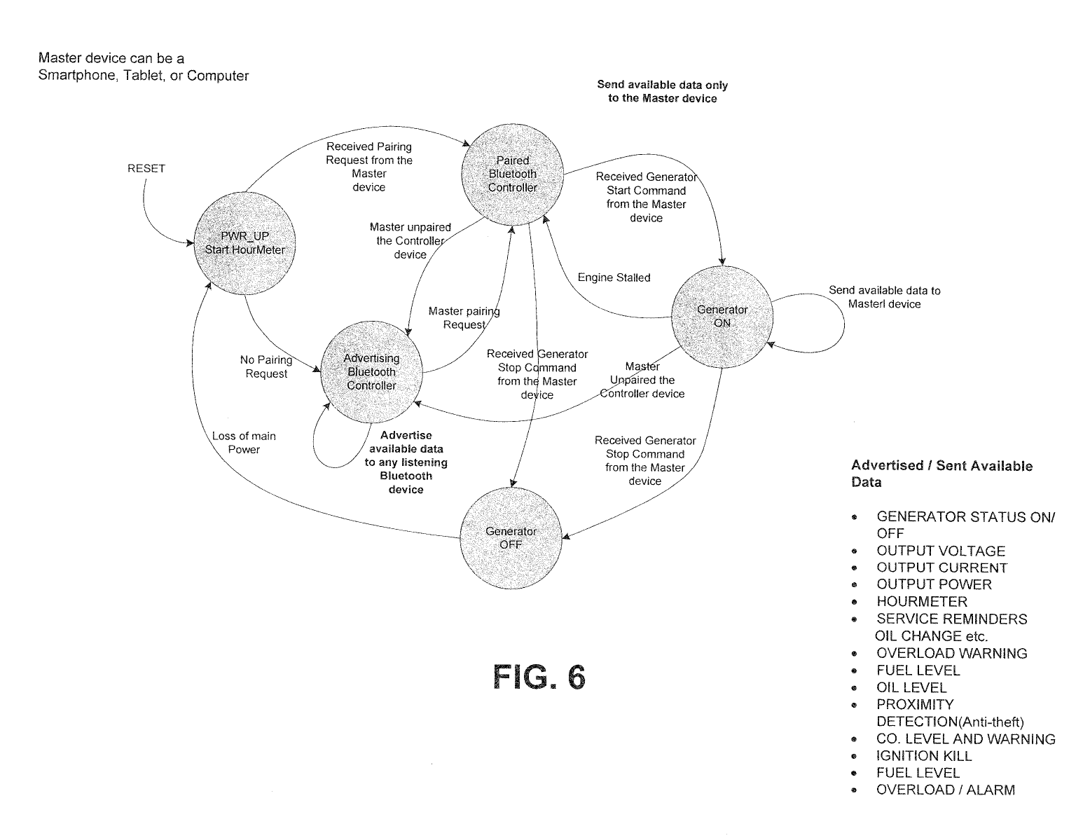

FIG. 6 illustrates a state diagram of the operations of an example of the control device (the Bluetooth SMART controller). The Bluetooth SMART controller and smart phone APP remotely control and monitor the operation of a power generator, including the start and stop of the generator, battery voltage, output voltage, running power consumption, ran hours, due and required maintenance, and service reminders will allow the user to remotely interact monitor, and control the generator with out leaving the house or walking up to the generator.

The controller can monitor available power generator sensors, process the onboard sensor output data and wirelessly send information about the current generator state of operation.

The available wireless data could be received by any listening smart device such as Smartphone or tablet when unpaired, or only by the paired master device when paired. Starting and stopping the generator could only take place over a secured communication link and, therefore, the wireless Bluetooth SMART controller must be paired to a master device. An anti-theft feature can be implemented using the Received Signal Strength indicator (RSSI) value usually sent from the controller. The RSSI value is an indication about how far the generator is from the receiving master device. If the RSSI signal is not received, an automatic shut-down is triggered. The APP can include help on generator operating tips, installation and support, wattage chart indicating power requirement per each typical house appliance, and frequently asked questions.

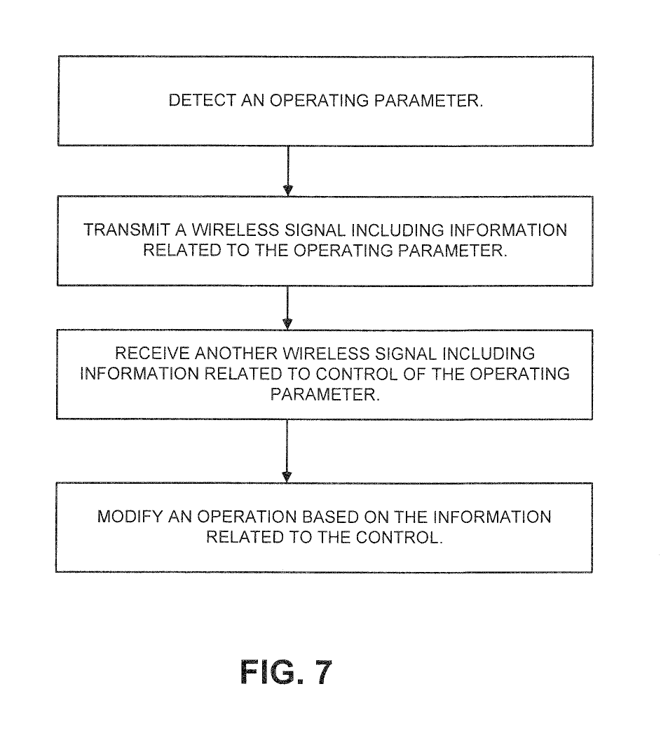

Illustrated in FIG. 7 is a method of operating a smart controller in accordance with one example embodiment of the present disclosure. The method is enabled by the sensor(s) detecting an operating parameter and transmitting data related to the operating parameter to the controller. The controller can detect a change in the operating parameter based on receiving the data and transmit a wireless signal including information related to the operating parameter to a remote computing device. The controller can receive a signal from the remote computing device that includes information related to control of the operating parameter from the computing device. Based on this signal, the controller can modify an operation of the power generator based on the information related to the control of the operating parameter.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A system comprising:
a non-transitory memory storing computer-executable instructions; and
a processor configured to facilitate execution of the computer-executable instructions to at least:
receive a first wireless signal comprising information related to a parameter of operation of a power generator device from the power generator device;
modify control information for an operation of the power generator device based on the information related to the parameter of operation of the power generator device; and
transmit a second wireless signal comprising the control information for the operation of the power generator device to the power generator device.

2. The system of claim 1, wherein the power generator device comprises a sensor configured to monitor the parameter of operation of the power generator device.

3. The system of claim 1, wherein the parameter of operation of the power generator device comprises a carbon monoxide emission from the power generator device.

4. The system of claim 3, wherein the control information is configured to shut down the operation of the power generator when the carbon monoxide emission from the power generation device is above a threshold.

5. The system of claim 1, wherein the parameter of operation of the power generator device comprises at least one of a battery voltage, an operating voltage of the power generator device, and a running power of the power generation device.

6. The system of claim wherein the parameter of operation of the power generator device further comprises a number of hours the power generator device has operated.

7. The system of claim 6, wherein the processor is further configured to facilitate execution of the computer-executable instructions to display at least one of a service reminder and a maintenance reminder based on the parameter of operation of a power generator device.

8. The system of claim 1, wherein at least one of the first wireless signal and the second wireless signal is transmitted according to a Bluetooth wireless transmission protocol.

9. The system of claim 8, wherein the Bluetooth wireless transmission protocol comprises Bluetooth Low Energy protocol.

10. A method comprising:
detecting, by a system comprising a non-transitory memory and a processor, a parameter of operation of a power generator device;
transmitting, by the system, a first wireless signal comprising information related to the parameter of operation of the power generator device;
receiving, by the system, a second wireless signal comprising control information for an operation of the power generator device to the power generator device based on the parameter of operation of the power generator device; and
modifying, by the system, the operation of the power generator device based on the control information.

11. The method of claim 10, wherein the parameter of operation of the power generator device comprises a carbon monoxide emission from the power generator device.

12. The method of claim 11, wherein the modifying further comprises shutting down the operation of the power generator when the carbon monoxide emission from the power generation device is above a threshold.

13. The method of claim 10, wherein the parameter of operation of the power generator device comprises at least one of a battery voltage, an operating voltage of the power generator device, and a running power of the power generation device.

14. The method of claim 10, wherein the parameter of operation of the power generator device further comprises a number of hours the power generator device has operated.

15. The method of claim 10, wherein at least one of the first wireless signal and the second wireless signal is transmitted according to a Bluetooth wireless transmission protocol.

16. A non-transitory computer-readable storage medium storing computer executable instructions that, when executed by a computing device comprising a processor, cause the computing device to perform operations, the operations comprising:
receiving a first wireless signal comprising information related to a parameter of operation of a power generator device from the power generator device;
modifying control information for an operation of the power generator device based on the information related to the parameter of operation of the power generator device; and
transmitting a second wireless signal comprising the control information for the operation of the power generator device to the power generator device.

17. The non-transitory computer-readable storage medium of claim 16, wherein the computing device comprises at least one of a smart phone device, a tablet computing device, a laptop computing device, and a personal digital assistant device.

18. The non-transitory computer-readable storage medium of claim 16, wherein the parameter of operation of the power generator device comprises a carbon monoxide emission from the power generator device; and
wherein the control information is configured to shut down the operation of the power generator when the carbon monoxide emission from the power generation device is above a threshold.

19. The non-transitory computer-readable storage medium of claim 16, wherein at least one of the first wireless signal and the second wireless signal is transmitted according to a Bluetooth wireless transmission protocol.

20. The non-transitory computer-readable storage medium of claim 17, wherein the Bluetooth wireless transmission protocol comprises Bluetooth Low Energy protocol.
